(19) United States
(12) Patent Application Publication
(10) Pub. No.: US 2021/0263870 A1
(43) Pub. Date: Aug. 26, 2021

(54) ACCELERATOR, OPERATION METHOD OF THE ACCELERATOR, AND AN APPARATUS INCLUDING THE ACCELERATOR

(71) Applicants: SAMSUNG ELECTRONICS CO., LTD., Suwon-si (KR); SNU R&DB Foundation, Seoul (KR)

(72) Inventors: Seung Wook LEE, Suwon-si (KR); Jung Ho AHN, Seoul (KR); Hweesoo KIM, Suwon-si (KR)

(73) Assignees: Samsung Electronics Co., Ltd., Suwon-si (KR); SNU R&DB Foundation, Seoul (KR)

(21) Appl. No.: 17/143,539

(22) Filed: Jan. 7, 2021

(30) Foreign Application Priority Data
Feb. 21, 2020 (KR) 10-2020-0021334

(51) Int. Cl. G06F 13/28; G06N 3/063

(52) U.S. Cl. CPC G06F 13/28; G06F 2213/28; G06N 3/063

(57) ABSTRACT

An accelerator, an operation method of the accelerator, and an accelerator apparatus including the accelerator are disclosed. The operation method includes receiving one or more workloads assigned by a main processor, performing at least one operation involved with the workloads in an internal memory of the accelerator or in a direct memory access (DMA) configured to control data input to or output from the internal memory, and providing a result of performing the at least one operation.

### CROSS-REFERENCE TO RELATED APPLICATIONS

This application claims the benefit under 35 USC § 119(a) of Korean Patent Application No. 10-2020-0021334 filed on Feb. 21, 2020, in the Korean Intellectual Property Office, the entire disclosures of which are incorporated herein by reference for all purposes.

### BACKGROUND

### 1. Field

The following description relates to an accelerator, an operation method of the accelerator, and an accelerator apparatus including the accelerator.

### 2. Description of Related Art

As artificial intelligence (AI) technology develops, a need for independent hardware for AI is increasing. AI may perform inference and learning through an operation. Thus, various devices are being developed as hardware dedicated to the implementation of AI.

Such dedicated hardware for AI may be embodied by, for example, a central processing unit (CPU) and a graphics processing unit (GPU), or by a field-programmable gate array (FPGA) and an application-specific integrated circuit (ASIC) that is repurposed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided an operation method of an accelerator, including receiving one or more workloads assigned by a main processor, performing at least one operation involved with the workloads in an internal memory of the accelerator or in a direct memory access (DMA) configured to control data input to or output from the internal memory, and providing a result of performing the at least one operation.

The performing of the at least one operation may include performing a reduction operation.

The reduction operation may be an operation where a quantity of data in a result of the operation may be less than a quantity of data required for the operation.

The reduction operation may be one of an inner product operation, a maximum (MAX) function, a minimum (MIN) function, an average (AVG) function, an addition, a multiplication, or an aggregation.

The performing of the at least one operation may include performing, in an operator disposed in the internal memory, the at least one operation on data stored in the internal memory.

The performing of the at least one operation may include performing, in an operator disposed in the DMA, the at least one operation on data read from the internal memory by the DMA.

The providing of the result may include providing the result of performing the at least one operation to at least one of a plurality of processing units in the accelerator and configured to perform the workloads, or to the internal memory.

The internal memory may include one or more of a level 0 memory accessible by one of a plurality of processing units configured to perform the workloads, a level 1 memory accessible by a portion of the plurality of the processing units, and a level 2 memory accessible by the plurality of the processing units, or a combination thereof.

The performing of the at least one operation may include performing the at least one operation through an extension offloaded to the internal memory and/or the DMA.

The accelerator may be comprised in a user terminal to which data to be recognized using a neural network based on a workload may be input, or in a server configured to receive the data to be recognized from the user terminal.

In another general aspect, there is provided an accelerator including processing units configured to perform one or more workloads assigned by a main processor, and a multilevel memory accessible by at least one of the processing units, wherein at least one of operations involved with the workloads is performed in an internal memory of the accelerator or in a direct memory access (DMA) configured to control data input to or output from the internal memory.

The at least one operation may include an operation where a quantity of data in a result of the operation may be less than a quantity of data required for the operation.

The at least one operation may be performed on data stored in the internal memory, in an operator disposed in the internal memory.

The at least one operation may be performed on data read from the internal memory by the DMA, in an operator disposed in the DMA.

A result of performing the at least one operation may be provided to at least one of the processing units comprised in the accelerator and configured to perform the workloads, or to the internal memory.

The internal memory may include one of a level 0 memory accessible by one of the processing units, a level 1 memory accessible by a portion of the processing units, and a level 2 memory accessible by the processing units, or a combination thereof.

In another general aspect, there is provided an accelerator apparatus including an accelerator comprising processing units configured to perform one or more workloads, and a multilevel memory having different access costs, and a main processor configured to assign the one or more workloads to the accelerator, wherein the accelerator is configured to perform at least one of operations involved with the one or more workloads in an internal memory of the accelerator or in a direct memory access (DMA) configured to control data input to or output from the internal memory.

Other features and aspects will be apparent from the following detailed description, the drawings, and the claims.

### BRIEF DESCRIPTION OF THE DRAWINGS

FIG. 1 is a diagram illustrating an example of an accelerator apparatus.

FIG. 2 is a diagram illustrating an example of an accelerator.

FIG. 3 is a diagram illustrating an example of a multilevel memory and an example of a main memory.

FIG. 4 is a diagram illustrating an example of performing a reduction operation in an extension of an internal memory and/or a direct memory access (DMA).

FIG. 5 is a diagram illustrating an example of components included in an accelerator apparatus.

FIGS. 6 and 7 are diagrams illustrating examples of an accelerator apparatus.

FIG. 8 is a diagram illustrating an example of an operation method of an accelerator.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Also, in the description of example embodiments, detailed description of structures or functions that are thereby known after an understanding of the disclosure of the present application will be omitted when it is deemed that such description will cause ambiguous interpretation of the example embodiments. Hereinafter, examples will be described in detail with reference to the accompanying drawings, and like reference numerals in the drawings refer to like elements throughout.

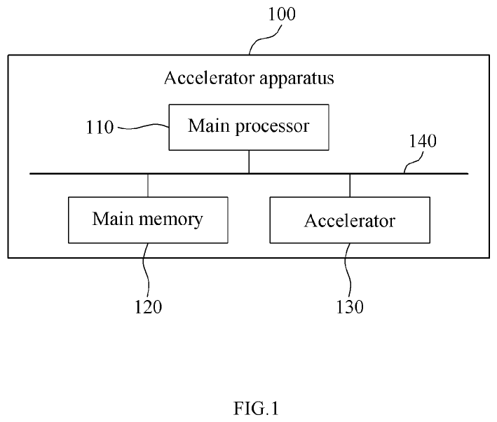

FIG. 1 is a diagram illustrating an example of an accelerator apparatus.

Referring to FIG. 1, an accelerator apparatus 100 includes a main processor 110, a main memory 120, and an accelerator 130. The main processor 110, the main memory 120, and the accelerator 130 may communicate with one another through a bus 140.

The main processor 110 may be a device configured to control operations of components included in the accelerator apparatus 100 and include a central processing unit (CPU), for example. The main processor 110 may assign one or more workloads to the accelerator 130. A workload may be an instruction that instructs the accelerator 130 to execute a neural network for object recognition, speech recognition, pattern recognition, computer vision, and machine translation, for example. The main processor 110 may assign, to the accelerator 130, the workloads based on one or more requested works or tasks.

The main memory 120 may be a memory disposed outside the accelerator 130, for example, a dynamic random-access memory (DRAM). When a memory present inside the accelerator 130 is insufficient for the accelerator 130 to perform the workloads, the main memory 120 may be used.

The main memory 120 may have a capacity larger than a multilevel memory inside the accelerator 130. However, a cost for an access from the accelerator 130 to the main memory 120 may be greater than a cost for an access to the multilevel memory. Such an access cost may indicate an amount of power and/or time that is used for accessing a memory and then reading or writing data. The multilevel memory described herein may be a memory included in the accelerator 130, and may also be referred to herein as an internal memory for the convenience of description.

The accelerator 130 may be an artificial intelligence (AI) accelerator configured to execute a neural network based on an assigned workload and infer data to be input, and be a separate processor distinguished from the main processor 110. That is, the accelerator 130 may simultaneously perform a single or a plurality of workloads assigned by the main processor 110. The accelerator 130 may process a workload that is more effectively processed by a separate dedicated processor than by the main processor 110 used for general purposes.

The neural network includes a plurality of layers. In an example, the neural network may include an input layer, a plurality of hidden layers, and an output layer. Each of the layers may include a plurality of nodes each referred to as an artificial neuron. Each of the nodes may indicate a calculation unit having at least one input and output, and the nodes may be connected to one another. A weight may be set for a connection between nodes, and the weight may be adjusted or changed. The weight may increase, decrease, or maintain a related data value, determining an influence of the data value on a final result. To each node included in the output layer, weighted inputs of nodes included in a previous layer may be input. A process in which weighted data is input from one layer to a subsequent layer of the layer may be referred to as propagation.

Operations based on the neural network may be performed in the accelerator 130. To perform the operations, a plurality of processing units and the multilevel memory that are included in the accelerator 130 may be used. The multilevel memory may be a memory accessible by at least one of the processing units, for example, a static RAM (SRAM). In an example, the SRAM may not be larger than DRAM in terms of memory capacity, but have a smaller access cost than the DRAM.

Based on a characteristic of the neural network, a relatively simple operation may be frequently performed on massive data. Although such a simple operation may be readily performed in a processing unit, a cost for bringing the massive data to the processing unit for the operation may be considerably large, and thus it may be ineffective in terms of an entire system.

In an example, the simple operation may be a reduction operation having a less data quantity of a result of the operation than a data quantity required for the operation. The reduction operation may include, for example, an inner product operation, a maximum (MAX) function, a minimum (MIN) function, an average (AVG) function, an addition, a multiplication, and an aggregation, and the like.

The MAX function may be an operation that outputs a greatest value from among given data, and the number of sets of data to be output may be one even though a quantity of the given data is large. When the MAX function operation is performed in a processing unit, the operation itself may be performed rapidly. However, a great amount of time may be used to invoke a great amount of data stored in the internal memory of the accelerator 130, and thus an overall operation efficiency may be degraded. Thus, it may be more effective to perform the MAX function operation first in the internal memory in which the data is stored, and then transmit one result data obtained by performing the operation to the processing unit.

Hereinafter, examples will be described in detail.

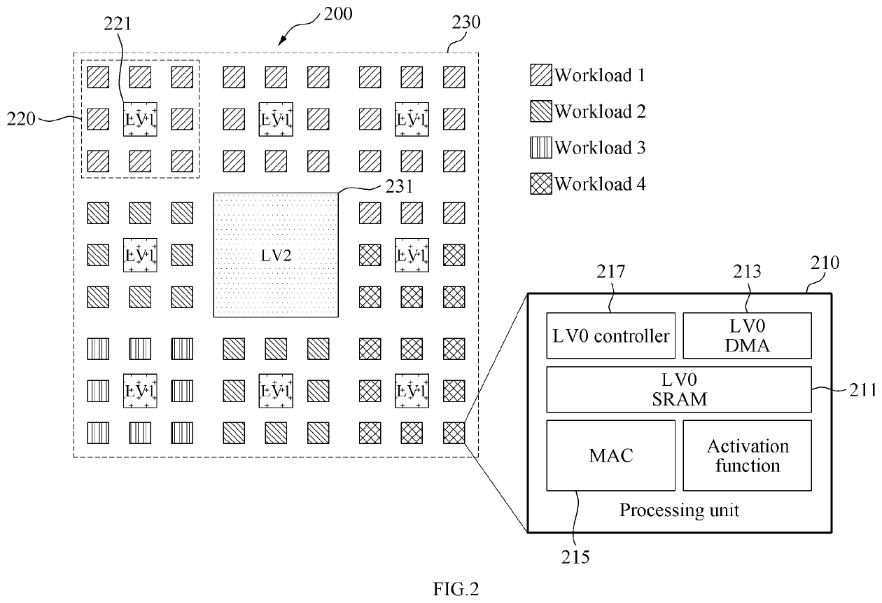

FIG. 2 is a diagram illustrating an example of an accelerator.

Referring to FIG. 2, an accelerator 200 includes a plurality of processing units and a multilevel memory accessible by at least one of the processing units. The multilevel memory may be a collective description of a level (LV) 0 memory 211, an LV1 memory 221, and an LV2 memory 231 in the accelerator 200.

One of the processing units, processing unit 210 includes an LV0 memory 211, an LV0 direct memory access (DMA) 213, a multiplier-accumulator (MAC) 215, and an LV0 controller 217. The processing unit 210 may be a neural processing unit (NPU), a graphics processing unit (GPU), a tensor processing unit (TPU), or the like.

The LV0 memory 211 may be a memory accessible by the corresponding processing unit 210. That is, the LV0 memory 211 may be accessible only by the processing unit 210 which is one of the processing units included in the accelerator 200.

The LV0 DMA 213 may monitor and/or profile data input to the LV0 memory 211 or output from the LV0 memory 211. The LV0 DMA 213 may control input data and/or output data of the LV0 memory 211 in place of the LV0 controller 217 according to an instruction from the LV0 controller 217. The LV0 DMA 213 may read data from the LV0 memory 211 or write data in the LV0 memory 211 based on information associated with a source, a destination, and a data size that are included in the instruction from the LV0 controller 217.

The LV0 DMA 213 may verify an access cost of the LV0 memory 211, usage information of the LV0 memory 211, and a type of data stored in the LV0 memory 211 by monitoring and/or profiling the data input to or output from the LV0 memory 211. For example, the LV0 DMA 213 may verify what percentage is indicated by the usage information of the LV0 memory 211, and which workload is involved with the data stored in the LV0 memory 211.

The MAC 215 may perform an operation involved with a workload assigned to the processing unit 210. For example, the MAC 215 may perform a multiply-accumulate operation on given data. In addition, the MAC 215 may apply an activation function to the given data. The activation function may be sigmoid, hyperbolic tangent (tanh), or a rectified linear unit (ReLU), for example.

The LV0 controller 217 may be a device configured to control components included in the processing unit 210. For example, the LV0 controller 217 may control the LV0 memory 211, the LV0 DMA 213, and the MAC 215.

The foregoing description of the processing unit 210 may be applied to each of the processing units included in the accelerator 200. That is, the accelerator 200 may include the processing units each performing an operation independently.

In an example, each n processing units from among the processing units may cluster together. In this example, n is a natural number greater than 1 and less than the number of the processing units included in the accelerator 200. That is, a portion of the processing units included in the accelerator 200 may cluster together to form a cluster, for example, a processing unit cluster 220.

Processing units included in the cluster 220 may share one LV1 memory 221. That is, the LV1 memory 221 may be accessible by the processing units in the cluster 220. For example, even though operations respectively performed in a first processing unit and a second processing unit among the processing units in the cluster 220 are different from each other, a portion of data required for the operations may be common. As the common data is stored in the LV1 memory 221, rather than in an LV0 memory included in each of the first processing unit and the second processing unit and thus the first processing unit and the second processing unit share the common data, an overall system operation efficiency may be improved. In the example of FIG. 2, each of the processing units may access an LV1 memory adjacent to each of the processing units.

Although not illustrated in FIG. 2, an LV1 DMA is provided to monitor and/or profile data input to or output from the LV1 memory 221. The LV1 DMA may control the input data and/or the output data of the LV1 memory 221. In addition, there an LV1 controller may also be provided. The LV1 controller may control the LV1 memory 221 and the LV1 DMA.

In addition, an entirety 230 of the processing units may share the LV2 memory 231. That is, the LV2 memory 231 may be accessible by all the processing units included in accelerator 200. For example, there may be processing units that share a portion of data required to perform an operation, although not clustering together to form a same group, among the processing units included in the accelerator 200. In this example, such processing units may not share the data through an LV1 memory, but effectively share the common data through the LV2 memory 231, thereby increasing the overall operation efficiency. Although not illustrated in FIG. 2, there is an LV2 DMA configured to monitor and/or profile data input to or output from the LV2 memory 231. In addition, there is also an LV2 controller configured to control the LV2 memory 231 and the LV2 DMA.

As described above, each of the processing units may access a respective LV0 memory, an LV1 memory adjacent to each of the processing units, and an LV2 memory of the accelerator 200, and use these memories to perform an assigned workload. The accelerator 200 may include the multilevel memory including hierarchical memories. In an example, each of an LV0 memory, an LV1 memory, and an LV2 memory may be an SRAM. The SRAM may have a lower access cost than a DRAM, which is a main memory.

In addition, a DMA and a controller included in the accelerator 200 may be of a hierarchical multilevel type.

In the example of FIG. 2, the processing units included in the accelerator 200 may simultaneously perform four workloads. For example, a workload with a relatively greater operation amount may be assigned to a greater number of processing units and processed therein, and a workload with a relatively less operation amount may be assigned to a smaller number of processing units and processed therein.

It is illustrated in FIG. 2, eight processing units of 64 processing units are clustered together to form eight clusters, and three level memories are used to perform the four workloads, for the convenience of description. However, various numbers of processing units, workloads, and levels may be applied without restriction.

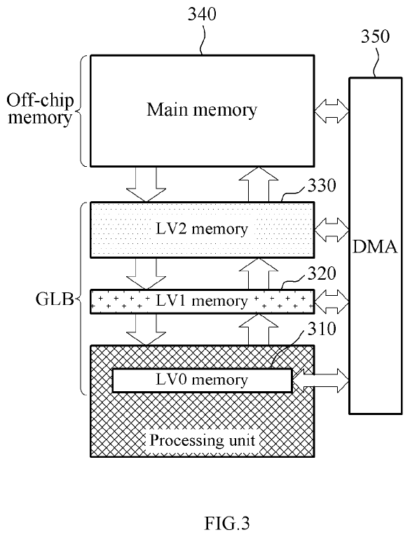

FIG. 3 is a diagram illustrating an example of a multilevel memory and an example of a main memory.

In FIG. 3, an LV0 memory 310, an LV1 memory 320, an LV2 memory 330, a main memory 340, a DMA 350 are illustrated in terms of their functionalities for the convenience of description.

The LV0 memory 310, the LV1 memory 320, and the LV2 memory 330 may be disposed as a global buffer (GLB) in an accelerator. The LV2 memory 330 may be a memory shared by a plurality of processing units included in the accelerator, and the LV1 memory 320 may be a memory shared by some of the processing units. The LV0 memory 310 may be included in a processing unit and not be shared with another processing unit. In the accelerator, there are the LV0 memory 310 provided in number corresponding to the number of the processing units included in the accelerator, the LV1 memory 320 provided in number corresponding to the number of clusters of the processing units, and one number of the LV2 memory 330 may be provided.

The main memory 340 may be an off-chip memory disposed outside the accelerator and include, for example, a DRAM, a three-dimensional (3D) memory such as a high bandwidth memory (HBM), and a processing in memory (PIM). The main memory 340 may also be referred to herein as an LV3 memory for the convenience of description.

The LV0 memory 310, the LV1 memory 320, the LV2 memory 330, and the main memory 340 may be used when a workload is performed in a processing unit, and a memory access cost may differ for each level. For example, the memory access cost may increase as the level increases. That is, an access cost of the LV0 memory 310 may be the lowest, and an access cost of the main memory 340 may be the highest.

The DMA 350 is also illustrated in terms of its functionality. A DMA may be separately provided for each level, and used to read or write data from or in a corresponding level memory. For example, there are an LV0 DMA configured to control input data and/or output data of the LV0 memory 310, an LV1 DMA configured to control input data and/or output data of the LV1 memory 320, an LV2 DMA configured to control input data and/or output data of the LV2 memory 330, and an LV3 DMA configured to control input data and/or output data of the main memory 340, separately. The LV0 memory 310, the LV1 memory 320, the LV2 memory 330, and the main memory 340 may exchange data with one another through the DMAs provided for respective levels.

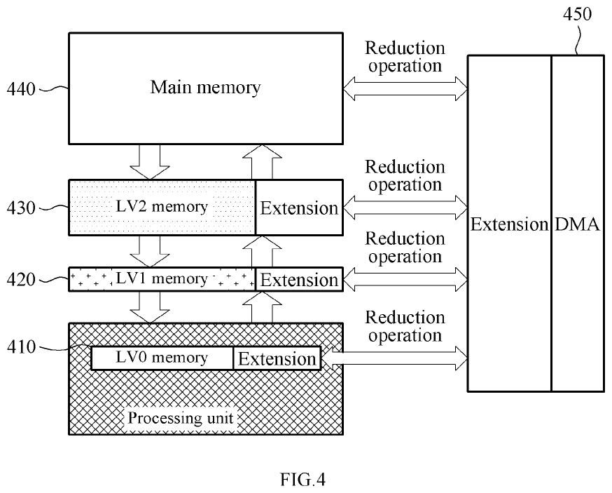

FIG. 4 is a diagram illustrating an example of performing a reduction operation in an extension of an internal memory and/or a DMA.

Referring to FIG. 4, a reduction operation may be performed through an extension of an internal memory and/or a DMA 450. The internal memory may be a collective description of an LV0 memory 410, an LV1 memory 420, and an LV2 memory 430.

In an example, the extension may indicate that performance of the reduction operation is offloaded to the internal memory or the DMA 450. The reduction operation may refer to a relatively simple operation with a less data quantity after the operation than a data quantity before the operation. That is, the reduction operation may be an operation with a less data quantity of a result of the operation than a data quantity required for the operation. The reduction operation may include, for example, an inner product operation, a MAX function, a MIN function, an AVG function, an addition, a multiplication, and an aggregation. To perform the reduction operation, a simple operator may be disposed in the internal memory or the DMA 450. For example, the operator may be embodied by an operation circuit to perform one of the inner product operation, the MAX function, the MIN function, the AVG function, the addition, the multiplication, and the aggregation.

In the example of FIG. 4, the reduction operation is first performed on data stored in the LV2 memory 430, and then a result of the reduction operation is moved to the LV1 memory 420. For example, when there is not an extension of the LV2 memory 430 that is illustrated in FIG. 4, massive data stored in the LV2 memory 430 may need to be moved to a processing unit through the DMA 450 for performing the reduction operation. In this example, due to such a massive amount of the data to be moved, an efficiency may be degraded. A result of the operation performed in the processing unit may be, for example, one data, and thus be transmitted from the processing unit to the LV1 memory 420 at a low cost. However, when there is the extension of the LV2 memory 430 as illustrated in FIG. 4, the reduction operation may be performed immediately in the LV2 memory 430 without a need to move the massive data from the LV2 memory 430 to the processing unit. In addition, only result data may need to be transmitted from the LV2 memory 430 to the LV1 memory 420 through the DMA 450, and thus it is possible to considerably reduce an overall system cost.

Although an example of the reduction operation being performed in the extension of the internal memory is described above, the reduction operation may be performed in the extension of the DMA 450 according to examples. For example, to use a result of a reduction operation by a processing unit when there is no extension, massive data stored in the internal memory may need to be transmitted to the processing unit through the DMA 450 such that the reduction operation is performed in the processing unit. In this example, a cost for moving the data may be considerably great as described above, and a movement of the massive data may need to be minimized to prevent a degradation of an overall system efficiency. In this example, when the reduction operation is performed in the extension of the DMA 450 and then only a result of the operation is transmitted from the DMA 450 to the processing unit, it is possible to prevent the movement of the massive data from the DMA 450 to the processing unit, and thus improve the system efficiency.

An extension configured to read, modify, and write stored data based on a reduction operation may be included in the internal memory indicating the LV0 memory 410, the LV1 memory 420, and the LV2 memory 430, and/or in the DMA 450. In an example, a movement of data based on the reduction operation may be performed on a unit smaller than a data unit processed in the DMA 450 of a general type, and the reduction operation may be a simple operation that is no longer divided. In addition, a high operation efficiency may not be expected from a DRAM optimized for data storage, and thus an extension may not be embodied in a main memory 440 corresponding to the DRAM and an extension may be embodied in the internal memory corresponding to an SRAM.

In an example, when one or more workloads are assigned by a main processor to an accelerator, operations involved with the workloads may be performed in the accelerator. Among the operations, there may be a complex operation such as a square root operation, and a simple operation such as an addition operation. A complexity of an operation may be determined based on, for example, a cost to be used for reading data required for the operation up to a position at which the operation is to be performed and a cost to be used for actually performing the operation (e.g., time and power consumption). Thus, it may be effective that a simple operation is performed in the extension of the internal memory and/or the DMA 450, whereas a complex operation is performed in a processing unit.

A result of the reduction operation performed in the extension of the internal memory and/or the DMA 450 may be transmitted to a processing unit for post-processing. In another example, the result of the reduction operation may be stored again in a corresponding internal memory, or transmitted to a memory of another level or to the main memory 440.

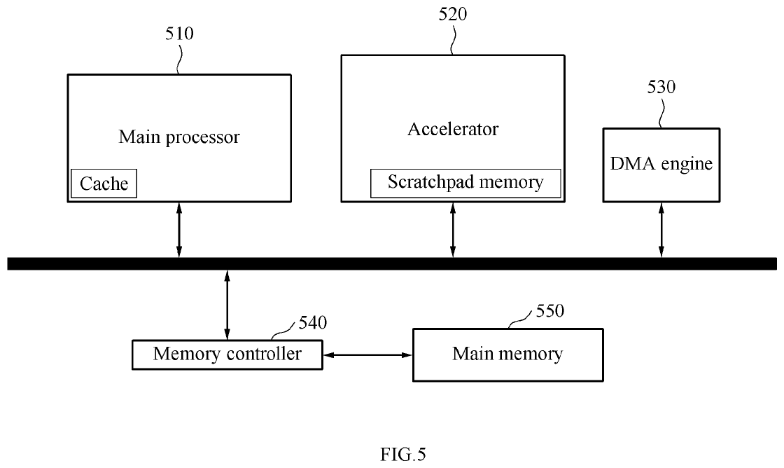

FIG. 5 is a diagram illustrating an example of components included in an accelerator apparatus.

Referring to FIG. 5, an accelerator apparatus includes a main processor 510, an accelerator 520, a DMA engine 530, a memory controller 540, and a main memory 550.

A reduction operation may be performed in a scratchpad memory in the accelerator 520. The scratchpad memory may be an on-chip memory included in the accelerator 520, for example, an SRAM accessible through an address space.

Although the main processor 510 includes a cache, the cache may not have a separate address space. Thus, it may not be guaranteed that specific data is included in the cache, and there may be a concern for a cache hit/miss. Thus, the cache may not be suitable to perform the reduction operation.

The DMA engine 530 may be a block that performs an operation of a DMA described above with reference to FIGS. 2 and 3. The main controller 540 may be a block for an access to the main memory 550. The main memory 550 may be a memory present outside the accelerator 520, for example, a DRAM.

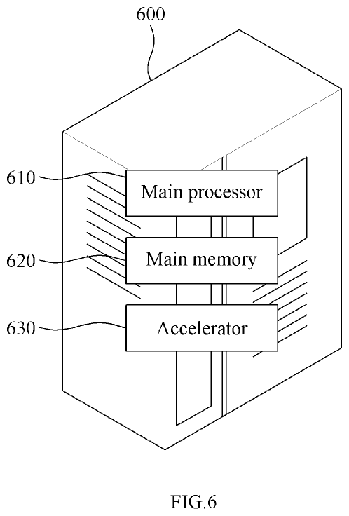

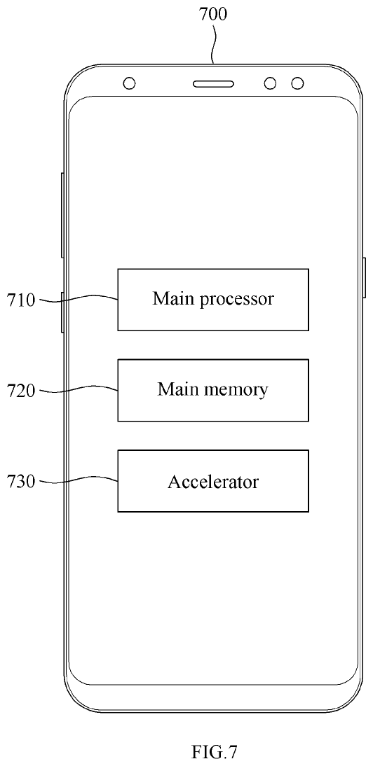

FIGS. 6 and 7 are diagrams illustrating examples of an accelerator apparatus.

Referring to FIG. 6, a server 600 includes a main processor 610, a main memory 620, and an accelerator 630. The main processor 610 may assign one or more workloads to the accelerator 630. The accelerator 630 may perform at least one of operations involved with the workloads using an internal memory of the accelerator 630 or a DMA configured to control data input to or output from the internal memory, and provide a result of performing the operation. In an example, the server 600 may be an accelerator apparatus.

Referring to FIG. 7, a user terminal 700 includes a main processor 710 (e.g., CPU), a main memory 720, and an accelerator 730. Each of these components may perform respective operations described herein. Although the user terminal 700 is illustrated as a smartphone in FIG. 7 for the convenience of description, the description provided above with reference to FIG. 7 may also be applicable to various computing devices such as a personal computer (PC), a tablet PC, and a laptop, various wearable devices such as a smart watch and smart eyeglasses, various home appliances such as a smart speaker, a smart TV, and a smart refrigerator, and other devices such as a smart vehicle, a smart kiosk, and Internet of things (IoT) devices, without restriction.

As described above, an accelerator (e.g., the accelerators 630 and 730) may be included in a user terminal (e.g., the user terminal 700) to which data to be recognized using a neural network based on a workload is input, or in a server (e.g., the server 600) configured to receive the data to be recognized from the user terminal.

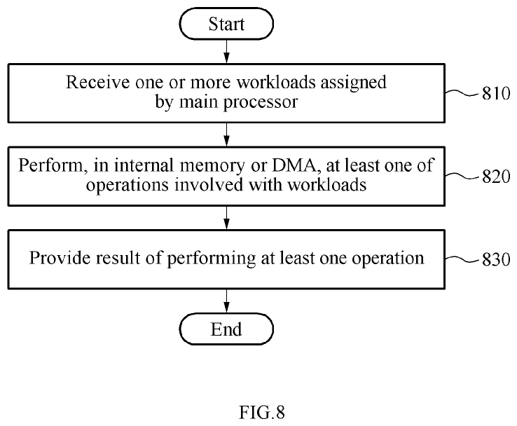

FIG. 8 is a diagram illustrating an example of an operation method of an accelerator. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. One or more blocks of FIG. 8, and combinations of the blocks, can be implemented by special purpose hardware-based computer, such as a processor, that perform the specified functions, or combinations of special purpose hardware and computer instructions.

An operation method to be described hereinafter may be performed by an accelerator.

Referring to FIG. 8, in operation 810, the accelerator receives, from a main processor, one or more workloads assigned by the main processor.

In operation 820, the accelerator performs at least one of operations involved with the workloads in an internal memory of the accelerator or in a DMA configured to control data input to or output from the internal memory. The accelerator may perform at least one reduction operation among the operations. The reduction operation may be an operation with a less data quantity of a result of the operation than a data quantity required for the operation. The reduction operation may be one of an inner product operation, a MAX function, a MIN function, an AVG function, an addition, a multiplication, and an aggregation.

In an example, in an operator disposed in the internal memory, the operation may be performed on data stored in the internal memory. In another example, in an operator disposed in the DMA, the operation may be performed on data read from the internal memory by the DMA.

In operation 830, the accelerator provides a result of performing the operation. The accelerator may provide the result of performing the operation to at least one of processing units included in the accelerator and configured to perform the workloads, or to the internal memory.

The accelerator, the accelerator apparatus including the accelerator, and other apparatuses, units, modules, devices, and other components described herein with respect to FIGS. 1-7 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIG. 8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An operation method of an accelerator, comprising:
receiving one or more workloads assigned by a main processor;
performing at least one operation involved with the workloads in an internal memory of the accelerator or in a direct memory access (DMA) configured to control data input to or output from the internal memory; and
providing a result of performing the at least one operation.

2. The operation method of claim 1, wherein the performing of the at least one operation comprises:
performing a reduction operation.

3. The operation method of claim 2, wherein the reduction operation is an operation where a quantity of data in a result of the operation is less than a quantity of data required for the operation.

4. The operation method of claim 2, wherein the reduction operation is one of an inner product operation, a maximum (MAX) function, a minimum (MIN) function, an average (AVG) function, an addition, a multiplication, or an aggregation.

5. The operation method of claim 1, wherein the performing of the at least one operation comprises:
performing, in an operator disposed in the internal memory, the at least one operation on data stored in the internal memory.

6. The operation method of claim 1, wherein the performing of the at least one operation comprises:
performing, in an operator disposed in the DMA, the at least one operation on data read from the internal memory by the DMA.

7. The operation method of claim 1, wherein the providing of the result comprises:
providing the result of performing the at least one operation to at least one of a plurality of processing units in the accelerator and configured to perform the workloads, or to the internal memory.

8. The operation method of claim 1, wherein the internal memory comprises one or more of a level 0 memory accessible by one of a plurality of processing units configured to perform the workloads, a level 1 memory accessible by a portion of the plurality of the processing units, and a level 2 memory accessible by the plurality of the processing units, or a combination thereof.

9. The operation method of claim 1, wherein the performing of the at least one operation comprises:
performing the at least one operation through an extension offloaded to the internal memory and/or the DMA.

10. The operation method of claim 1, wherein the accelerator is comprised in a user terminal to which data to be recognized using a neural network based on a workload is input, or in a server configured to receive the data to be recognized from the user terminal.

11. A non-transitory computer-readable storage medium storing commands that, when executed by a processor, cause the processor to perform the operation method of claim 1.

12. An accelerator comprising:
processing units configured to perform one or more workloads assigned by a main processor; and
a multilevel memory accessible by at least one of the processing units,
wherein at least one of operations involved with the workloads is performed in an internal memory of the accelerator or in a direct memory access (DMA) configured to control data input to or output from the internal memory.

13. The accelerator of claim 12, wherein the at least one operation comprises an operation where a quantity of data in a result of the operation is less than a quantity of data required for the operation.

14. The accelerator of claim 12, wherein the at least one operation is performed on data stored in the internal memory, in an operator disposed in the internal memory.

15. The accelerator of claim 12, wherein the at least one operation is performed on data read from the internal memory by the DMA, in an operator disposed in the DMA.

16. The accelerator of claim 12, wherein a result of performing the at least one operation is provided to at least one of the processing units comprised in the accelerator and configured to perform the workloads, or to the internal memory.

17. The accelerator of claim 12, wherein the internal memory comprises one of a level 0 memory accessible by one of the processing units, a level 1 memory accessible by a portion of the processing units, and a level 2 memory accessible by the processing units, or a combination thereof.

18. An accelerator apparatus comprising:
an accelerator comprising processing units configured to perform one or more workloads, and a multilevel memory having different access costs; and
a main processor configured to assign the one or more workloads to the accelerator,
wherein the accelerator is configured to perform at least one of operations involved with the one or more workloads in an internal memory of the accelerator or in a direct memory access (DMA) configured to control data input to or output from the internal memory.
